(19) United States
(12) Patent Application Publication
(10) Pub. No.: US 2019/0243935 A1
(43) Pub. Date: Aug. 8, 2019

(54) A SENSOR PLACEMENT METHOD USING STRAIN GAUGES AND ACCELEROMETERS FOR STRUCTURAL MODAL ESTIMATION

(71) Applicant: Dalian University of Technology, Dalian, Liaoning (CN)

(72) Inventors: Tinghua YI, Dalian, Liaoning (CN); Xueyang PEI, Dalian, Liaoning (CN); Hongnan LI, Dalian, Liaoning (CN)

(21) Appl. No.: 16/342,902

(22) PCT Filed: Mar. 16, 2018
(86) PCT No.: PCT/CN2018/079271

§ 371 Date: Apr. 17, 2019

(30) Foreign Application Priority Data
Jun. 26, 2017 (CN) 201710491282.3

(51) Int. Cl. G06F 17/50; G01P 15/18; G01P 15/08; G01L 1/22; G01M 5/00

(52) U.S. Cl. CPC G06F 17/5018; G01P 15/18; G06F 2217/16; G01L 1/2206; G01M 5/0008; G01P 15/0802

(57) ABSTRACT

A structural modal estimation based sensor placement method of strain gauges and accelerometers, including three steps: selection of initial accelerometer positions, selection of positions to be estimated and selection of strain gauge positions. First, use the modal confidence criterion and modal information redundancy to select the initial accelerometer position. Second, combined with the actual situation, when some positions cannot arrange the accelerometer, define the positions where the displacement modal estimation is needed. Third, use the strain mode shapes estimates the displacement mode shapes of the positions to be estimated, and uses the modal estimation effect to select the positions of the strain gauges. This can fully utilize the monitoring data collected by the strain gauges. The obtained sensor placement conforms to the modal confidence criterion and contains few modal redundancy information, which is an effective joint sensor placement method.

### TECHNICAL FIELD

The presented invention belongs to the technical field of sensor placement for structural health monitoring, and relates to the modal estimation of bridge structures using the structural data from strain gauges and accelerometers.

### BACKGROUND

The selection of the sensor locations placed on a structure is the first step in structural health monitoring, which aims at using a limited number of sensors to obtain as much useful structural information as possible. The displacement modal information plays an important role in the structural analysis where the mode shapes and the modal coordinates are usually used to perform damage detection, model updating and response reconstruction. The sensor placement methods for capturing structural modal information can be divided into two categories. One is the mode shape based sensor placement method. The modal assurance criterion (MAC) method selects the sensor locations to make the mode shapes at these locations distinguishable. The redundancy information can be taken into account to reduce the redundant modal information contained in the mode shapes of the selected sensor locations. The other category of sensor placement methods is based on the estimation of the modal coordinates. The effective influence (EI) method determines the sensor locations based on a large norm value of the modal Fisher information matrix to guarantee the quality of the estimated modal coordinates. The kinetic energy (KE) method uses the mass matrix together with the modal Fisher matrix, in which the kinetic energy of the structure is simultaneously maximized.

The existing sensor placement methods for capturing structural displacement modal information are usually based on the selection of accelerometer locations. However, in the bridge structural health monitoring systems, accelerometers and strain gauges have a wide range of applications. Sensor placement based on a single type of sensor cannot be applied to situations with multiple types of sensors. In addition, the displacement modal information contained in the strain data is helpful for the structural analysis, which is rarely taken into account in the existing sensor placement methods. Therefore, the research on the sensor placement using strain gauges and accelerometers for capturing more structural displacement modal information is very meaningful.

### SUMMARY

To jointly use strain gauges and accelerometers to obtain accurate structural displacement modal information, the present invention provides a dual-type sensor placement method.

The procedures of the dual-type sensor placement method are as follows:

1. Selection of the initial accelerometer locations.

The initial three-dimensional accelerometer locations are selected according to the modal confidence criterion, and the information redundancy threshold is set in the selection process to avoid excessive redundancy of the displacement modal information contained in the displacement mode shapes of the accelerometer locations.

Step 1.1: Set each node of the structural finite element model to be the candidate locations of the accelerometers. The strain gauges are placed at ⅓ and ⅔ of the beam element length between the finite element nodes. Four corners of each section are the four specific positions of the candidate strain gauge locations. The candidate accelerometer and strain gauge locations are numbered.

Step 1.2: Use the EI method to obtain the initial a three-dimensional accelerometer locations. The accelerometer locations are determined according to the contribution of each position to the linear independence of the modal Fisher information matrix:

conᵢ=1−det(I₃−ϕ₃ᵢ(ϕ^{T}ϕ)ϕ₃ᵢ^{T}) (1)

where conᵢ is the contribution of the ith accelerometer location to the linear independence of the modal Fisher information matrix; ϕ is the displacement mode shape matrix of all the candidate accelerometer locations; ϕ₃ᵢ is the three rows of the displacement mode shape matrix corresponding to the ith accelerometer location. If the value of conᵢ is close to 0, it means that the accelerometer location has almost no contribution and can be deleted; if the value of conᵢ is close to 1, it means that the position is very important and needs to be retained. The method starts from all the candidate accelerometer locations, and one location is deleted at a time until all the accelerometer locations are determined.

Step 1.3: Considering the continuity of the modal shapes, when the locations of two sensors are too close, the displacement modal information contained in these two locations will have a high degree of similarity. The Frobenius norm is used here to calculate the information redundancy between sensors:

$${γ}_{i , j} = 1 - \frac{{‖ {φ}_{3 i} - {φ}_{3 j} ‖}_{F}}{{‖ {φ}_{3 i} ‖}_{F} + {‖ {φ}_{3 j} ‖}_{F}} \qquad ( 2 )$$

where γ_{i,j} is the redundancy coefficient between the ith and jth accelerometer locations. When γ_{i,j} is close to 1, it means that the displacement modal information of the two locations is very similar. A redundancy threshold h can be set to evaluate the redundancy coefficients between the remaining candidate accelerometer locations and the selected accelerometer locations. If the redundancy coefficient is greater than the redundancy threshold, the corresponding candidate location is deleted.

Step 1.4: Select a new accelerometer location from the candidate accelerometer locations. Add the location that produces the smallest value of the off-diagonal elements of the MAC matrix for the existing sensor placement position. The MAC matrix is

$${MAC}_{i , j} = \frac{{( {φ}_{* , i}^{T} {φ}_{* , j} )}^{2}}{( {φ}_{* , i}^{T} {φ}_{* , i} ) ( {φ}_{* , j}^{T} {φ}_{* , j} )} \qquad ( 3 )$$

where ϕ_{*, i} and ϕ_{*, j} are the ith and jth column of the displacement mode shape matrix of the selected accelerometer locations. The MAC_{i, j} value represents the distinguishability of the two displacement mode shape columns.

Step 1.5: Observe whether there are remaining candidate accelerometer locations to be selected. If not, go to step 6; if there are, go back to step 3.

Step 1.6: Select the initial p accelerometer locations as the sensor placement with the redundancy threshold h. The determination of the redundancy threshold value needs to be combined with the MAC values.

Step 1.7: If the redundancy threshold value can be smaller, return to step 3 and decrease the value of h; if when the redundancy threshold value is reduced, the sensor placement has lager MAC values, go to the next step.

Step 1.8: In combination with the various selected redundancy threshold values, a suitable value of h is finally determined, and the locations of the initial three-dimensional accelerometers are also determined.

2. Determine the estimated locations

Sometimes when the initial accelerometer locations have been determined, the number of accelerometers needs to be reduced for various reasons. Here, two situations are taken into account. In the first case, the accelerometers are expensive so that the number of accelerometers needs to be reduced. In the second case, due to some practical reasons, the accelerometers sometimes cannot be placed on some of the initial p selected locations.

Step 2.1: See the reason of the decrease in the number of the initial accelerometer locations. If it is the economic reason, go to step 2.2; otherwise, go to step 2.3.

Step 2.2: Since the initial position is determined by the sequential algorithm, d positions of the initial accelerometer locations are deleted sequentially from the back to the front and then go to step 2.4.

Step 2.3: According to the actual situation, d positions of the initial accelerometer locations are not suitable for placing the accelerometers. These d locations are deleted.

Step 2.4: Since the initial accelerometer locations are selected according to the performance criteria, the modal information contained in the deleted positions has important significance for the structural analysis. These positions are defined as the estimated locations, and the displacement mode shapes at the estimated locations will be estimated by the strain mode shapes at the strain gauge locations.

3. Select strain gauge locations for modal estimation

Using the relationship between the strain mode shape and the displacement mode shape, the strain mode shapes obtained by strain gauges can be used to estimate the displacement mode shapes of the deleted accelerometer locations.

Mü+C\dot{u}+Ku=f (4)

Where: M , C , K are the mass, damping and stiffness matrix of the structure respectively; f is the external force vector; u is the generalized displacement vector of all nodes of the structure, and each node has 6 degrees of freedom corresponding to the translational displacements and rotational displacements of three directions (x, y, z); the upper point of \dot{u} represents a derivation of time.

ε=Tu=Tϕq=φq (5)

where: ε is the selected strain vector, the strains are normal strains here; T is the transformation matrix between the selected strains and the nodal displacements; ϕ is the displacement mode shape matrix of the structure; q is the modal coordinate; φ is strain mode shape matrix corresponding to the selected strain positions.

The relationship between the strain mode shape and the displacement mode shape can be expressed as

φ=Tϕ (6)

where φ is the strain mode shape matrix of the strain gauge locations; ϕ is the displacement mode shape matrix of the FE model; T is the transformation matrix.

After obtaining the relationship between the strain mode shape and the displacement mode shape, the procedures for the estimation of the displacement mode at the estimated locations and the selection of the strain gauge locations are as follows:

Step 3.1: Determine the displacement mode shape matrix of the estimated locations ϕ^{k}, where k is the number rows of ϕ^{k}. ϕ^{k} consists of k rows of ϕ. In the modal estimation, the candidate positions of the strain gauges select the four corners of the cross sections at ⅓ and ⅔ of the beam element length between the finite element nodes, mainly because the effect of the modal estimation is seriously affected at the mid-span.

Step 3.2: Determine the candidate positions of the strain gauges in combination with the specific situation of the structure, and then determine the transformation matrix T.

Step 3.3: The right side of Eq. (6) can be further written as

Tϕ=T^{k}ϕ^{k}+T^{n-k}ϕ^{n-k} (7)

where: T^{k} is the kth column vector in the transformation matrix T, which corresponds to the position of the estimated locations; T^{n-k} consists of the remaining n-k columns of the transformation matrix; ϕ^{n-k} consists of the n-k remaining row vectors of the displacement mode shape matrix; n is the number of rows of the displacement mode shape matrix. Then, delete the zero row vectors in T^{k}.

Step 3.4: In practice, the strain mode shapes obtained from the strain data are usually different from the actual strain mode shapes. The prediction errors (differences) of the strain mode shapes are often caused by the model errors and measurement noise. Therefore, the expression of Eq. (6) is improved as

φ=Tϕ+w (8)

where: w is the prediction error matrix, which is generally assumed to be a stationary Gaussian noise. w₍ᵢ₎ is the ith column of w, which has a mean of zero and a covariance matrix Cov(w(₍ᵢ₎)=σᵢI. The selection of the strain gage locations can be expressed in Eq. (8) by changing the number of rows on the left side of the equation, and the different lines of φ correspond to the positions of different strain gages. Then, Eq. (8) is further expressed as

Sφ=S(Tϕ+w) (9)

where: S is the selection matrix consisting of 0 and 1, and the number of rows of S is equal to the number of the selected strain gauges. Only one element in each row is 1 and the rest are 0.

Substituting Eq. (7) into Eq. (9) results in

S(φ−T^{n-k}ϕ^{n-k})=ST^{k}ϕ^{k}+Sw (10)

From Eq. (10), the estimated displacement mode shapes of the estimated locations are expressed as

\tilde{ϕ}₍ᵢ₎^{k}=(T^{k}S^{T}ST^{k})⁻¹T^{kT}S^{T}S(φ₍ᵢ₎−T^{n-k}ϕ₍ᵢ₎^{n-k}) (11)

where: the subscript (i) represents the ith column of the corresponding matrix such that \tilde{ϕ}₍ᵢ₎^{k} is the ith column of the estimated displacement mode shapes, φ₍ᵢ₎ is the ith column of φ, and ϕ₍ᵢ₎^{n-k} is the ith column of ϕ^{n-k}.

The covariance matrix of \tilde{ϕ}₍ᵢ₎^{k} is expressed as:

Cov(\tilde{ϕ}₍ᵢ₎^{k})=σᵢ²(T^{kT}S^{T}ST^{k})⁻¹ (12)

The diagonal elements of the covariance matrix represent the estimation error of the estimated mode shapes, and the trace value of covariance matrix can be used to quantify the estimation error:

error(\tilde{ϕ}₍ᵢ₎^{k})=σᵢtrace(\sqrt{(T^{kT}S^{T}ST^{k})⁻¹}) (13)

where: trace is the symbol of gaining trace values.

The estimation error of the estimated mode shapes of all mode orders can be seen as the sum of the trace values of covariance matrices of different mode orders.

$$error ( {\tilde{φ}}^{k} ) = {\sum }_{i = 1}^{n} error ( {\tilde{φ}}_{( i )}^{k} ) = {\sum }_{i = 1}^{n} {σ}_{i} trace ( \sqrt{{( {T}^{k T} {S}^{T} {ST}^{k} )}^{- 1}} ) \qquad ( 14 )$$

where: N is the column number of \tilde{ϕ}^{k} .

Eq. (14) can be further expressed as:

error(\tilde{ϕ}^{k})∝trace(√(T^{kT}S^{T}ST^{k})⁻¹) (15)

where: ∝ indicates the proportional sign. It can be seen that the estimation error of \tilde{ϕ}^{k} is determined by the positions of the selected strain gauges and the positions of the estimated displacement mode shapes. By changing the selection matrix S (selecting different strain gauge locations), the estimation error of the estimated displacement mode shapes can be adjusted. The optimal strain gauge locations correspond to the smallest estimation error.

Step 3.5: The p-d remaining initial accelerometers and the k selected strain gauges are the final sensor placements.

The beneficial effects of the present invention are as follows: The sensor placement method proposed by the invention can fully utilize the monitoring data of different types of sensors to obtain the displacement modal information of the structure. The choice of the accelerometer locations fully considers the distinguishability of mode shapes and redundant information contained in the mode shapes. The locations of the strain gauges are corresponding to the minimum estimation error of the displacement mode shapes on the estimated locations, which guarantees the accuracy of the estimated displacement mode shape.

### DESCRIPTION OF DRAWINGS

FIG. 1 is the bridge benchmark model.

FIG. 2 shows the accelerometer locations and the estimated locations.

FIG. 3 shows the final placement of accelerometers and strain gauges.

### DETAILED DESCRIPTION

The present invention is further described below in combination with the technical solution and the drawings.

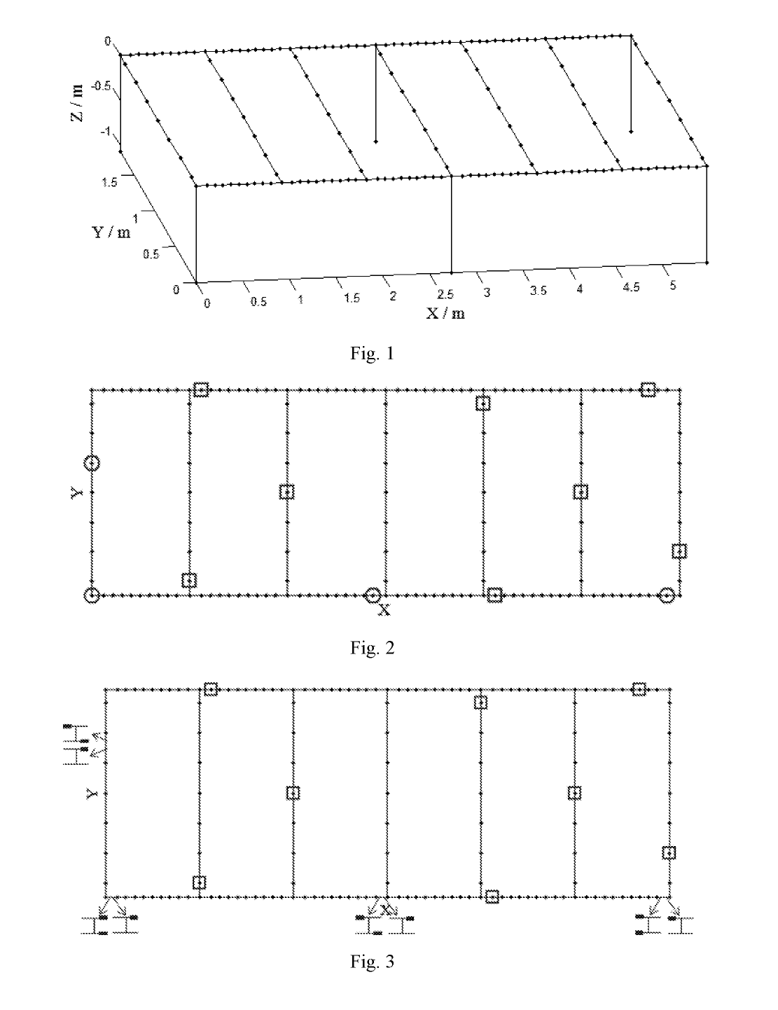

The method was verified using a bridge benchmark model. FIG. 1 shows the finite element model of the bridge benchmark structure. There are 177 nodes in total, in which each node has six degrees of freedom. The Euler beam element model is used to simulate the structure, and the relationship between the structural strain mode and the displacement mode is analyzed. After the relationship between the strain mode and the displacement mode has been determined, the sensor placement method for strain gauges and the accelerometers proposed by the present invention can be used.

FIG. 2 shows the positions of the selected accelerometer locations and the estimated locations, where the squares represent the accelerometer locations and the circles represent the estimated locations.

Use the displacement modal estimation method given in the invention, and then the strain gauge locations corresponding to the minimum estimation error are finally selected.

FIG. 3 shows the results of the final sensor placement of accelerometers and strain gauges. The positions of the accelerometer locations are indicated by squares, and the positions of the strain gauges on the I-beam section are indicated by solid rectangles.

We claims:

1. A sensor placement method using strain gauges and accelerometers for structural modal estimation, wherein the steps are as follows:
(1) selection of the initial accelerometer locations
step 1.1: set each node of the structural finite element model to be candidate locations of accelerometers; strain gauges are placed at ⅓ and ⅔ of beam element length between finite element nodes; four corners of each section are four specific positions of the candidate strain gauge locations; the candidate accelerometer and strain gauge locations are numbered;
step 1.2: use the EI method to obtain initial α three-dimensional accelerometer locations; the accelerometer locations are determined according to contribution of each position to linear independence of modal Fisher information matrix:
conᵢ=1−det(I₃−ϕ₃ᵢ(ϕ^{T}ϕ)ϕ₃ᵢ^{T}) (1)
where conᵢ is the contribution of the ith accelerometer location to the linear independence of the modal Fisher information matrix; I₃ is identity matrix; ϕ is displacement mode shape matrix of all the candidate accelerometer locations; ϕ₃ᵢ is the three rows of the displacement mode shape matrix corresponding to the ith accelerometer location;
step 1.3: Frobenius norm is used here to calculate information redundancy between sensors:
$${γ}_{i , j} = 1 - \frac{{‖ {φ}_{3 i} - {φ}_{3 j} ‖}_{F}}{{‖ {φ}_{3 i} ‖}_{F} + {‖ {φ}_{3 j} ‖}_{F}} \qquad ( 2 )$$
where γ_{i, j} is the redundancy coefficient between the ith and jth accelerometer locations;
step 1.4: select a new accelerometer location from the candidate accelerometer locations according to MAC;
$${MAC}_{i , j} = \frac{{( {φ}_{* , i}^{T} {φ}_{* , j} )}^{2}}{( {φ}_{* , i}^{T} {φ}_{* , i} ) ( {φ}_{* , j}^{T} {φ}_{* , j} )} \qquad ( 3 )$$
where ϕ_{*, i} and ϕ_{*, j} are ith and jth column of the displacement mode shape matrix of the selected accelerometer locations; the MAC_{i, j} value represents distinguishability of the two displacement mode shape columns;
step 1.5: observe whether there are remaining candidate accelerometer locations to be selected; if not, go to step 1.6; if there are, go back to step 1.3;
step 1.6: select the initial p accelerometer locations as the sensor placement with the redundancy threshold h;
step 1.7: if the redundancy threshold value can be smaller, return to step 1.3 and decrease the value of h; if when the redundancy threshold value is reduced, the sensor placement has lager MAC values, go to the next step;
step 1.8: in combination with the various selected redundancy threshold values, a suitable value of h is finally determined, and the locations of the initial three-dimensional accelerometers are also determined;
(2) determine estimated locations step 2.1: see reason of the decrease in the number of the initial accelerometer locations; if it is the economic reason, go to step 2.2; otherwise, go to step 2.3;
step 2.2: since the initial position is determined by the sequential algorithm, d positions of the initial accelerometer locations are deleted sequentially from the back to the front and then go to step 2.4;
step 2.3: according to actual situation, d positions of the initial accelerometer locations are not suitable for placing the accelerometers; these d locations are deleted;
step 2.4: these d positions are defined as the estimated locations, and the displacement mode shapes at the estimated locations will be estimated by the strain mode shapes at the strain gauge locations;
(3) select strain gauge locations for modal estimation
using relationship between the strain mode shape and the displacement mode shape, the strain mode shapes obtained by strain gauges can be used to estimate the displacement mode shapes of the deleted accelerometer locations;
Mü+C\dot{u}+Ku=f (4)
where: M , C , K are the mass, damping and stiffness matrix of the structure respectively; f is the external force vector; u is the generalized displacement vector of all nodes of the structure, and each node has 6 degrees of freedom corresponding to the translational displacements and rotational displacements of three directions (x, y, z); the upper point of \dot{u} represents a derivation of time.
ε=Tu=Tϕq=φq (5)
where: ε is the selected strain vector, the strains are normal strains here; T is the transformation matrix between the selected strains and the nodal displacements; ϕ is the displacement mode shape matrix of the structure; q is the modal coordinate; φ is strain mode shape matrix corresponding to the selected strain positions;
the relationship between the strain mode shape and the displacement mode shape can be expressed as
φ=Tϕ (6)
where φ is the strain mode shape matrix of the strain gauge locations; ϕ is the displacement mode shape matrix of the FE model; T is the transformation matrix;
after obtaining the relationship between the strain mode shape and the displacement mode shape, the procedures for the estimation of the displacement mode at the estimated locations and the selection of the strain gauge locations are as follows:
step 3.1: determine the displacement mode shape matrix of the estimated locations ϕ^{k} , where k is the number rows of ϕ^{k}; ϕ^{k} consists of k rows of ϕ;
step 3.2: determine the candidate positions of the strain gauges in combination with the specific situation of the structure, and then determine the transformation matrix T;
step 3.3: the right side of Eq. (6) can be further written as
Tϕ=T^{k}ϕ^{k}+T^{n-k}ϕ^{n-k} (7)
where: T^{k} is the kth column vector in the transformation matrix T, which corresponds to the position of the estimated locations; T^{n-k} consists of the remaining n-k columns of the transformation matrix; ϕ^{n-k} consists of the n-k remaining row vectors of the displacement mode shape matrix; n is the number of rows of the displacement mode shape matrix; then, delete the zero row vectors in T^{k};
step 3.4: in practice, the strain mode shapes obtained from the strain data are usually different from the actual strain mode shapes; therefore, the expression of Eq. (6) is improved as
φ=Tϕ+w (8)
where: w is the prediction error matrix, which is generally assumed to be a stationary Gaussian noise; w₍ᵢ₎ is the ith column of w, which has a mean of zero and a covariance matrix Cov(w₍ᵢ₎=σᵢI ; the selection of the strain gage locations can be expressed in Eq. (8) by changing the number of rows on the left side of the equation, and the different lines of φ correspond to the positions of different strain gages; then, Eq. (8) is further expressed as
Sφ=S(Tϕ+w) (9)
where: S is the selection matrix consisting of 0 and 1, and the number of rows of S is equal to the number of the selected strain gauges; only one element in each row is 1 and the rest are 0;
substituting Eq. (7) into Eq. (9) results in
S(φ−T^{n-k}ϕ^{n-k})=ST^{k}ϕ^{k}+Sw (10)
from Eq. (10), the estimated displacement mode shapes of the estimated locations are expressed as
\tilde{ϕ}₍ᵢ₎^{k}=(T^{k}S^{T}ST^{k})⁻¹T^{kT}S^{T}S(φ₍ᵢ₎−T^{n-k}ϕ₍ᵢ₎^{n-k}) (11)
where: the subscript (i) represents the ith column of the corresponding matrix such that \tilde{ϕ}₍ᵢ₎^{k} is the ith column of the estimated displacement mode shapes, φ₍ᵢ₎ is the ith column of φ, and ϕ₍ᵢ₎^{n-k} is the ith column of ϕ^{n-k};
the covariance matrix of \tilde{ϕ}₍ᵢ₎^{k} is expressed as:
Cov(\tilde{ϕ}₍ᵢ₎^{k})=σᵢ²(T^{kT}S^{T}ST^{k})⁻¹ (12)
the diagonal elements of the covariance matrix represent the estimation error of the estimated mode shapes, and the trace value of covariance matrix can be used to quantify the estimation error:
error(\tilde{ϕ}₍ᵢ₎^{k})=σᵢtrace(\sqrt{(T^{kT}S^{T}ST^{k})⁻¹}) (13)
where: trace is the symbol of gaining trace values;
the estimation error of the estimated mode shapes of all mode orders can be seen as the sum of the trace values of covariance matrices of different mode orders;
$$error ( {\tilde{φ}}^{k} ) = {\sum }_{i = 1}^{n} error ( {\tilde{φ}}_{( i )}^{k} ) = {\sum }_{i = 1}^{n} {σ}_{i} trace ( \sqrt{{( {T}^{k T} {S}^{T} {ST}^{k} )}^{- 1}} ) \qquad ( 14 )$$
where: N is the column number of \tilde{ϕ}^{k};
Eq. (14) can be further expressed as:
error(\tilde{ϕ}^{k})∝trace(√(T^{kT}S^{T}ST^{k})⁻¹) (15)
where: ∝ indicates the proportional sign; it can be seen that the estimation error of ϕ^{k} is determined by the positions of the selected strain gauges and the positions of the estimated displacement mode shapes; by changing the selection matrix S, selecting different strain gauge locations, the estimation error of the estimated displacement mode shapes can be adjusted; the optimal strain gauge locations correspond to the smallest estimation error;
step 3.5: The p-d remaining initial accelerometers and the k selected strain gauges are the final sensor placements.
